(19) United States
(12) Patent Application Publication
(10) Pub. No.: US 2014/0014281 A1
(43) Pub. Date: Jan. 16, 2014

(54) Shade with a Shear Pin and Method for Pretensioning a Shade

(71) Applicants: Willis Jay Mullet, Gulf Breeze, FL (US); Darrin W. Brunk, Pensacola, FL (US)

(72) Inventors: Willis Jay Mullet, Gulf Breeze, FL (US); Darrin W. Brunk, Pensacola, FL (US)

(73) Assignee: HomeRun Holdings Corporation, Pensacola, FL (US)

(21) Appl. No.: 13/548,767

(22) Filed: Jul. 13, 2012

(51) Int. Cl. E06B 9/62; B23P 11/00; E06B 9/72; E06B 9/44; E06B 9/68

(52) U.S. Cl. 160/311; 160/309; 160/315; 29/428

(57) ABSTRACT

A roller shade is provided. The roller shade may include: a roller; an axle located in the roller; an adjustable counterbalancing mechanism configured to counter balance a rotation of the roller wherein the counterbalancing mechanism is configured to impart a rotational force on the roller and the rotational force is adjusted by rotating the axle; and a locking mechanism attached to the roller and configured to lock the axle at a given angular orientation, wherein the locking mechanism includes a shear pin. A method of tensioning a counterbalancing mechanism may also be provided. The method may include: mounting the counterbalancing mechanism to a shaft; mounting the lock wheel to the shaft; turning the shaft to tension the counterbalancing mechanism; and inserting a shear pin into a hole in the lock wheel to lock the shaft in place.

### FIELD OF THE INVENTION

The present invention relates generally to a roller shade used to as a window covering. More particularly, the present invention relates to a mechanism for providing a spring biased counterbalance for the roller shade.

### BACKGROUND OF THE INVENTION

Roller shades are used to provide a window covering that selectively allows privacy and/or limits light coming through a window. As windows are sometimes desired to be covered and uncovered, shades may be moved from a covering position to an unobstructed position by rolling the roller shade to a raised position.

The roller shades may be manually operated by a user or in other instances may be operated by an electric motor. In order to reduce the amount of effort that a user or a motor must exert to operate the roller shade, a spring counterbalancing system may be used to mitigate the effects of the weight of the shade when moving the roller shade up or down.

In order for the counterbalancing mechanism to be effective, it may be desirable to pretension the counter balancing mechanism to a desired tension level in order to provide an appropriate amount of force to exert in counterbalancing the weight of the shade.

Pretensioning the counterbalancing mechanism may be above the ability of the average user of a roller shade. As such, the pretensioning step may be desired to be accomplished at the factory before the roller shade reaches the consumer and/or ultimate user.

Accordingly, it is desirable to provide a method and/or apparatus that permits a counterbalancing mechanism in a roller shade to be pretensioned at the factory so that when the consumer takes possession of the roller shade, an appropriate amount of tension has been applied in the counterbalancing mechanism.

### SUMMARY OF THE INVENTION

The foregoing needs are met, to a great extent, by certain embodiments in accordance with the present invention, wherein in one aspect an apparatus is provided that in some embodiments a mechanism is provided that allows a counterbalancing mechanism to be pretensioned. In other embodiments, a method is provided which includes pretensioning a counterbalancing mechanism.

In accordance with one embodiment of the present invention, a roller shade is provided. The roller shade may include: a roller; an axle located in the roller; an adjustable counterbalancing mechanism configured to counter balance a rotation of the roller wherein the counterbalancing mechanism is configured to impart a rotational force on the roller and the rotational force is adjusted by rotating the axle; and a locking mechanism attached to the roller and configured to lock the axle at a given angular orientation, wherein the locking mechanism includes a shear pin.

In accordance with another embodiment of the present invention, a method of tensioning a counterbalancing mechanism may be provided. The method may include: mounting the counterbalancing mechanism to a shaft; mounting the lock wheel to the shaft; turning the shaft to tension the counterbalancing mechanism; and inserting a shear pin into a hole in the lock wheel to lock the shaft in place.

In accordance with yet another embodiment of the present invention, a roller shade may be provided. The roller shade may include: means for rolling; means for rotatabling supporting the means for rolling; means for counterbalancing configured to counter balance a rotation of the means for rolling wherein the means for counterbalancing is configured to impart a rotational force on the means for roll and the rotational force is adjusted by rotating the mean for rotatabling supporting the means for rolling; and means for locking attached to the means for rolling and configured to lock the means for rotatabling supporting the means for rolling at a given angular orientation, wherein the means for locking includes a means for fusing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a shade or blind assembly in accordance with an embodiment of the invention.

FIG. 2 is a perspective view that has sections removed in order to reveal internal components of a blind or shade assembly in accordance with an embodiment of the invention.

FIG. 3 is an enlarged, partial perspective view that has sections removed to reveal internal components of a shade or blind assembly in accordance with an embodiment of the invention.

FIG. 4 is an enlarged, perspective view of an internal assembly that has a section removed in order to reveal internal parts within the internal assembly in accordance with an embodiment of the invention.

FIG. 5 is an enlarged, perspective, sectioned view of an internal components of a mechanism used in a shade or blind assembly in accordance with an embodiment of an invention.

### DETAILED DESCRIPTION

The invention will now be described with reference to the drawing figures, in which like reference numerals refer to like parts throughout. An embodiment in accordance with the present invention provides a blind assembly that includes a counterbalancing mechanism that can be pretensioned to a desired level of tensioning.

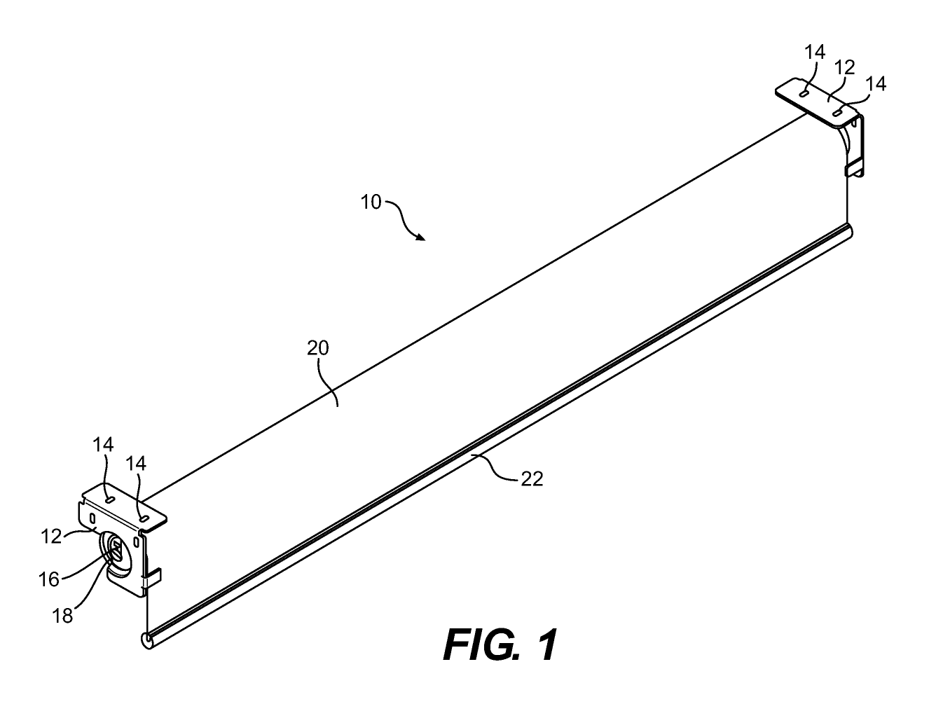

FIG. 1 illustrates a blind assembly 10 in accordance with an embodiment of the invention. The blind assembly 10 may be mounted upon brackets 12. The brackets 12 may be mounted to a window frame or a wall to place the blind assembly 10 in a desirable location within respect to a window. The brackets 12 may include mounting holes 14 which may be used to mount the brackets 12 via fasteners that may be inserted into the mounting holes 14. The brackets 12 may include a slot 16 which is dimensioned and configured to accept and support a shaft 18 of the blind assembly 10. The blind assembly 10 may include blind material 20. The blind material 20 may include a rail 22 which may be used as a surface or handle for a user to grasp to pull down the blind material 20 from the blind assembly 10.

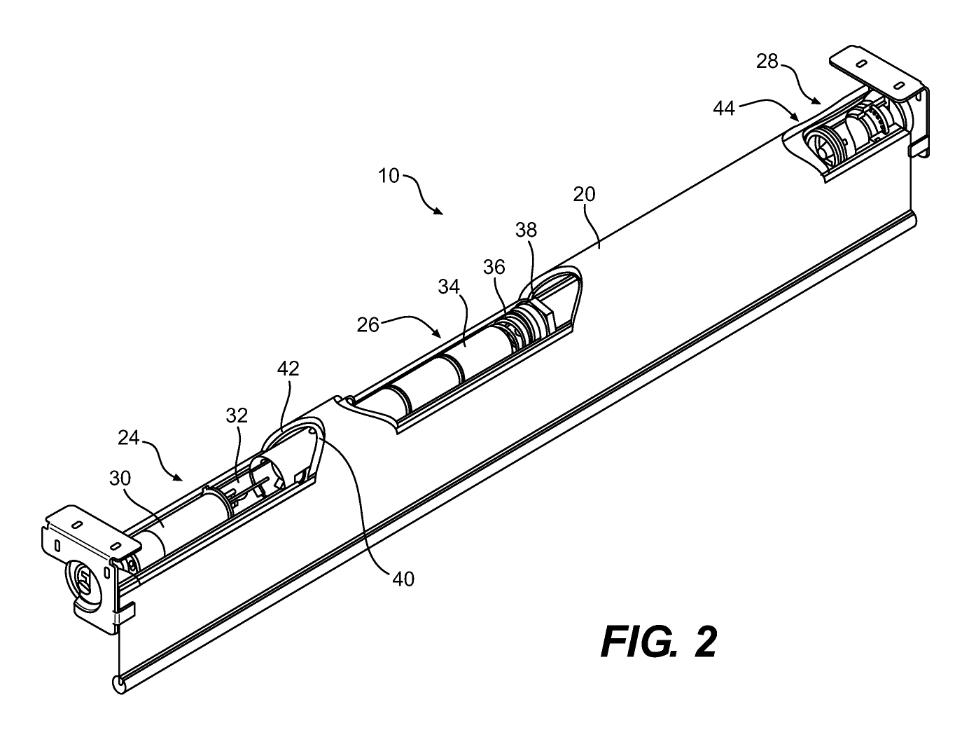

FIG. 2 is a perspective view of a blind assembly 10 having cut out portions 24, 26, and 28. The cut out portions 24, 26, and 28 permit the illustration of components within the blind assembly 10 which are normally hidden by the blind material 20. As can be seen, viewing through cut out portion 24, the blind assembly 10 may include a motor assembly 30. The motor assembly 30 may be controlled by a controller 32. The motor assembly 30 may also include the power source and/or battery or batterys 34. Batterys 34 may be held in place by a spring 36 as illustrated in cut out portion 26. The spring 36 may be compressed between a back stop 38 and the batteries or power source 34. In some embodiments, the motor assembly 30 may be located outside of the spool 40 and mechanically attached to the spool 40 to rotate the spool 40.

The blind material 20 is rolled around and attached to a spool 40. The spool 40 may be referred to, in some instances, as a shade roll 40. The spool 40 typically surrounds the motor assembly 30 battery or power source 34 and other internal components of the blind assembly 10. The spool 40 provides a surface for the blind material 20 to be mounted to and to wrap around. The blind material 20 may wrap in several layers around the spool 40. The several layers of blind material 20 may be referred to as wrapping 42. As illustrated in cut out 28, a counterbalance spring assembly 44 may also be included in the blind assembly 10. The counterbalance spring assembly 44 may be contained within the spool 40.

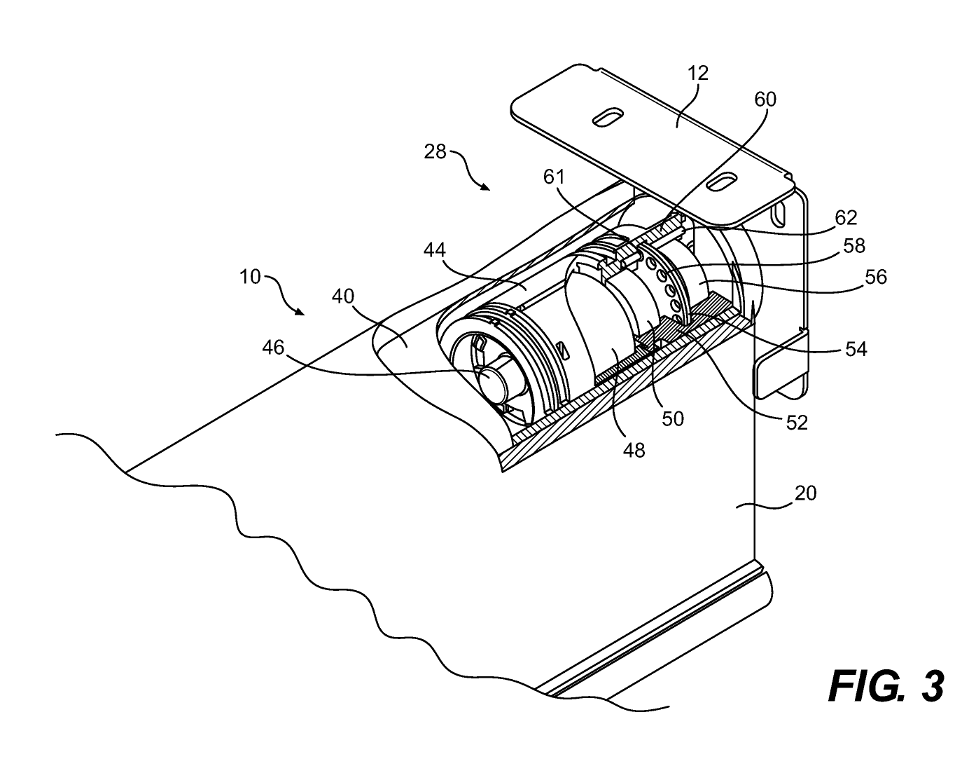

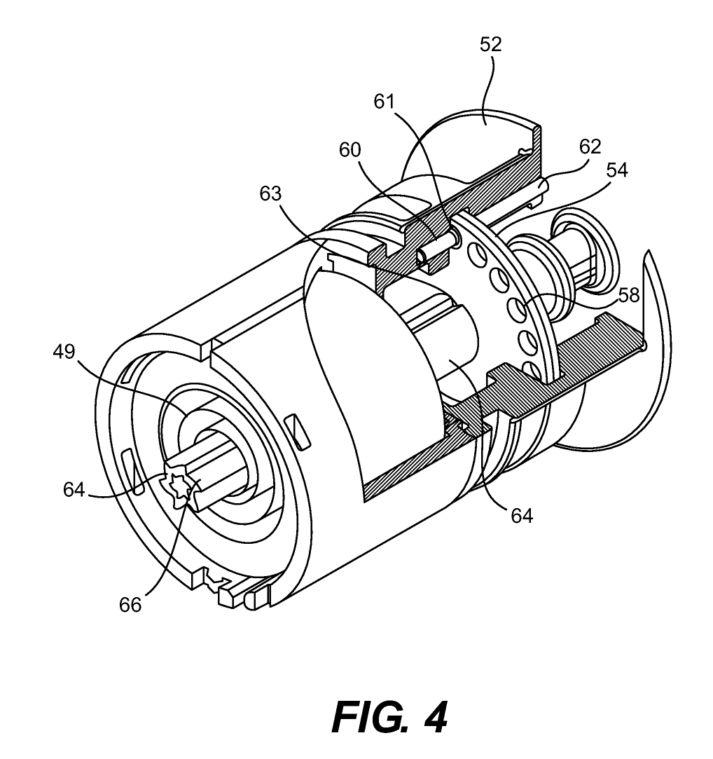

FIG. 3 is an enlarged view of the portion of the blind assembly 10 and cut out 28 illustrating the counterbalance assembly 44. The counterbalance assembly 44 may include a shaft cover 46, a power spring housing 48 which surrounds and protects a power spring 49 [better illustrated in FIG. 4]. The counterbalance spring assembly 44 may also include a bearing 50 contained within a bearing housing 52. A rotation disk 54 is located between the bearing 50 and a second bearing 56. The bearings 50 and 56 permit the rotation disk 54 and other aspects of the counterbalance spring assembly 44 to rotate in a reduced friction manner. The rotation disk 54 may include apertures or holes 58. The bearing housing 52 defines a void referred to as the shear pin seat 60. The shear pin seat 60 provides a place for the shear pin 62 to be contained within the bearing housing 52. The shear pin 62 is located in one of the apertures or holes 58 and is configured to hold the rotation disk 54 in place. Thus, upon assembly, the manufacturer may rotate the rotation disk 54 to provide a desired amount of pretensioning of the counterbalance spring assembly 44 and then insert the shear pin 60 into one of the apertures 54 that most closely aligns with the shear pin seat 60 to provide the desired amount of counterbalancing. A user, after mounting the blind assembly, can either remove or break the shear pin 60 in order to rotate the blind assembly 10. In some embodiments, the shear pin 60 may contain a narrow portion 61 to facilitate being broken by a user.

FIG. 4 is an enlarged partially cut away view of the bearing housing 52 shown in FIG. 3. Contained within the bearing housing 52 is a rotation disk 54 having holes 58 and a shear pin 62 is illustrated in the holes 58 in the rotation disk. The bearings 50 and 54 have been removed to better expose the shaft 64 upon which the rotation disk 54 rotates. The rotation disk 54 includes teeth 63 which engage a groove or grooves 66 in the shaft 64.

The power spring 49 is also shown in FIG. 4 in a coiled position. The power spring 49 may be attached to the shaft 64 by the groove or grooves 66 and is configured to urge the shaft 64 to rotate. However, the rotation of the shaft 64 is checked by the shear pin 62 in the holes 58 in the rotation disk pressing against the shear pin seat 60. The grooves 66 and the shaft 64 and the power spring 49 are illustrated in FIG. 4 because the shaft cover 64, shown in FIG. 3 has been removed.

The power spring 49 and some embodiments is pretensioned by turning the rotation disk 54 in the opposite direction the power spring 44 is urging the shaft 64 to rotate, which in turn, rotates the shaft 64 in the opposite direction the power spring 49 is biasing the shaft 64. This rotation will increase the tension in the power spring 49. This tensioning of the power spring 49 will provide a counterbalance for the weight of the line material 20, allowing the rotation of the spool 40 to be done relatively easily.

As mentioned above, the blind material 20 is not rotated off the spool 40 until the shear pin 62 is either removed or broken by a user. Once the shear pin 62 has been removed or broken by a user, the force of the power spring 49 no longer checked by the shear pin 62, but is rather checked by the weight of the line material 20, as shown, for example, in FIG. 3.

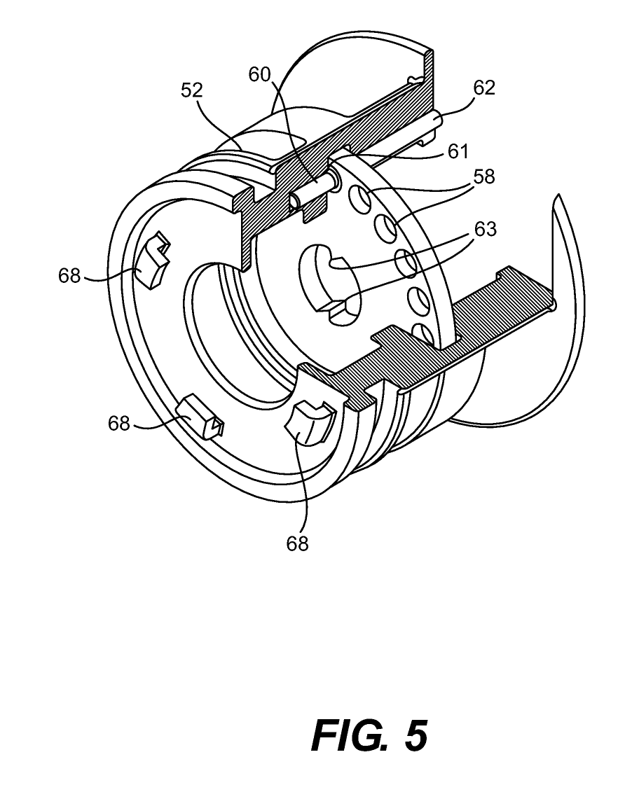

FIG. 5 is an enlarged partially cut away illustrative portion of the bearing housing 52 illustrating the shear pin 62 and the shear pin seat 60. The shear pin 62 is also located in the holes 58 and the rotation disk 54. The teeth 63 and rotation disk 64 are illustrated as the shaft 64 has been removed for clarification. Attaching structure 68 is shown attached to the bearing housing 52 it allows the bearing housing 52 to attach to the power spring housing 48 shown, for example, in FIG. 4.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A roller shade comprising:
a roller;
an axle located in the roller;
an adjustable counterbalancing mechanism configured to counter balance a rotation of the roller wherein the counterbalancing mechanism is configured to impart a rotational force on the roller and the rotational force is adjusted by rotating the axle; and
a locking mechanism attached to the roller and configured to lock the axle at a given angular orientation, wherein the locking mechanism includes a shear pin.

2. The roller shade of claim 1, wherein the locking mechanism includes a locking wheel mounted on the axle and having a plurality of holes to allow a user to select which hole to insert the shear pin to lock the axle to the roller.

3. The roller of claim 2, wherein the locking wheel is located between two bearings.

4. The roller of claim 2, further comprising a spring associated with the counter balancing mechanism and rotation of the locking wheel tensions or relieves tension on the spring depending upon which way the locking wheel is rotated.

5. The roller of claim 2, wherein the locking wheel has a hole through which the axle extends.

6. The roller of claim 2, further comprising projections on the wheel that extend into voids in the axle.

7. The roller of claim 1, further comprising shade material attached to the roller.

8. The roller of claim 1, wherein the shear pin has a reduced diameter section.

9. The roller of claim 1, wherein the locking mechanism includes a bearing housing and the bearing housing has a void for receiving the shear pin.

10. The roller of claim 1, further comprising a motor configured to rotate the roller to raise and lower the shade.

11. The roller of claim 10, wherein the motor is located in the roller.

12. The roller of claim 10, wherein the motor is battery operated.

13. The roller of claim 1, wherein the counterbalancing mechanism includes a power spring.

14. The roller of claim 1, wherein the shear pin is made of one of plastic and metal.

15. A method of tensioning a counterbalancing mechanism comprising:
mounting the counterbalancing mechanism to a shaft;
mounting the lock wheel to the shaft;
turning the shaft to tension the counterbalancing mechanism; and
inserting a shear pin into a hole in the lock wheel to lock the shaft in place.

16. The method of claim 15, further comprising attaching blind material around the counterbalancing mechanism.

17. The method of claim 15, further comprising shipping the tensioned counterbalancing mechanism to a place of installation.

18. The method of claim 17, further comprising intentionally breaking the shear pin.

19. The method of claim 18, rotating the counterbalancing mechanism by one of rising and lowering a shade.

20. A roller shade comprising:
means for rolling;
means for rotatabling supporting the means for rolling;
means for counterbalancing configured to counter balance a rotation of the means for rolling wherein the means for counterbalancing is configured to impart a rotational force on the means for roll and the rotational force is adjusted by rotating the mean for rotatabling supporting the means for rolling; and
means for locking attached to the means for rolling and configured to lock the means for rotatabling supporting the means for rolling at a given angular orientation, wherein the means for locking includes a means for fusing.
